(19) United States
(12) Patent Application Publication
(10) Pub. No.: US 2013/0022060 A1
(43) Pub. Date: Jan. 24, 2013

(54) DEVICE FOR TRANSMITTING LIGHT ENERGY AND ASSOCIATED TRANSMISSION METHOD

(71) Applicants: Gael GABOREL, Angouleme (FR); Jean-Louis AUGUSTE, Limoges (FR); Georges HUMBERT, Rilhac Rancon (FR); Frederic GEROME, Limoges (FR); Jean-Marc BLONDY, Limoges (FR); Benoit BEAUDOU, Limoges (FR)

(72) Inventors: Gael GABOREL, Angouleme (FR); Jean-Louis AUGUSTE, Limoges (FR); Georges HUMBERT, Rilhac Rancon (FR); Frederic GEROME, Limoges (FR); Jean-Marc BLONDY, Limoges (FR); Benoit BEAUDOU, Limoges (FR)

(73) Assignee: Meggitt (France), Paris (FR)

(21) Appl. No.: 13/456,775

(22) Filed: Apr. 26, 2012

(30) Foreign Application Priority Data
Apr. 26, 2011 (FR) FR 11 53558

(51) Int. Cl. H01S 3/30

(52) U.S. Cl. 372/6

(57) ABSTRACT

A device is provided that includes an optical fiber and an assembly illuminating the optical fiber capable of illuminating the optical fiber at an upstream end. The optical fiber includes a hollow core and an anti-resonant annular cladding arranged around the hollow core. The illuminating assembly generates a focused beam of Airy spot shape for injection into the input of the optical fiber.

The present invention concerns a device for transmitting light energy including
a hollow-core optical fiber;
an assembly for illuminating the optical fiber capable of illuminating the optical fiber at an upstream end.

The device is intended to be used for micro-machining for example, for spectroscopy, for the laser ignition of engines and turbines or in other applications requiring the generating and conveying of a high energy light beam.

### BACKGROUND

In all these fields, it is sometimes necessary to transmit short pulses through an optical fiber, for example lasting less than 100 nanoseconds, of high energy, for example of the order of one microjoule or millijoule.

To do so, it is known to use multimodal optical fibers in silica.

In this respect, and to avoid deterioration of the fiber, it is necessary to limit the transmitted energy taking into account the maximum acceptable power density in the core of the fiber.

Beyond the damage threshold of silica, the optical fiber undergoes irreversible degradation, most often a few centimetres after the coupling with the illuminating assembly.

To reduce power density, the size of the core can be increased. However, the solution does not give satisfaction since the spatial quality of the beam is deteriorated, in particular on account of the increase in the number of guided modes.

To overcome this problem at least in part, it is known to use hollow-core optical fibers. In particular, it is possible to coat the inside of a glass capillary a few hundred micrometres in diameter with dielectric layers acting as reflector to trap the light energy in the air core. However, these optical fibers have a core of large size to support numerous modes, which degrades the spatial quality of the beam leaving the fiber. In addition, the fabrication of these fibers is difficult and available lengths are less than a few metres.

One partial solution to this problem is described for example in U.S. Pat. No. 7,099,533. In the device disclosed in this document, a hollow-core optical fiber with photonic band gap (HC-PBG) is used. The optical fibers of this type comprise a micro-structured inner cladding in silica surrounding a hollow core. The microstructure of the cladding has tube rings with point connections spaced along the axis of the fiber. This type of cladding creates a photonic band gap allowing the propagation of a very limited number of modes in the air core.

Such fibers have satisfactory transmission properties, since their attenuations are of the order of one dB per kilometre. However, their transmission window is relatively narrow and the propagated wavelength is directly related to the periodicity of the connections of the microstructured cladding, the consequence of which is to limit the diameter of the air core to a few micrometres.

In addition, the size of the core of these fibers is very limited owing to fabrication stresses, which reduces power transmission. Finally, part of the energy of the laser beam is propagated in the microstructuring (inner cladding) which is likely to degrade more particularly the silica bridges linking the tubes together, causing irreversible degradation of the fiber.

### SUMMARY OF THE INVENTION

It is therefore one objective of the invention to provide a light power transmission device including an illuminating assembly and an optical fiber capable of transmitting pulses of high energy, in particular higher than one millijoule, the device being highly robust.

For this purpose the subject of the invention is a device of the aforementioned type characterized in that the fiber includes an anti-resonant annular cladding arranged around the hollow core, the illuminating assembly generating a focused beam of Airy spot shape intended to be injected into the upstream end of the optical fiber.

The device of the invention may include one or more of the following characteristics taken alone or in any technically possible combinations:
the focused beam of Airy spot shape generated by the illuminating assembly has a central disk of diameter substantially equal to the maximum cross expanse of the hollow core of the optical fiber;
the illuminating assembly includes a laser source and a coupler between the laser source and the optical fiber, the coupler including at least one convergent coupling lens having a downstream focal point arranged in the vicinity of the upstream end of the optical fiber;
the illuminating assembly includes a spatial filtering member capable of preventing the passing of the secondary rings of the Airy spot-shaped beam;
the spatial filtering member is arranged facing the upstream end of the optical fiber;
the spatial filtering member is arranged between two auxiliary lenses located upstream of the upstream end;
the illuminating assembly includes a laser source capable of generating a near field, uniform circular beam;
the laser source is chosen from among a laser source including an unstable cavity and gradient-reflectivity mirror or a laser source including a spatial beam-modulation system;
the anti-resonant annular cladding includes at least one ring of main adjacent hollow tubes, the main hollow tubes delimiting between them intermediate tubes of smaller cross-section that the cross-section of the main adjacent tubes;
the hollow core is limited by a central tube advantageously of polygonal shape;
the maximum cross-section dimension of the hollow cores is more than 5 micrometres, in particular more than 20 micrometres and is further particularly between 50 micrometres and 500 micrometres;
the illuminating assembly is capable of emitting a plurality of light pulses of energy higher than 1 millijoule.

A further subject of the inventions is a method for transmitting light energy including the following steps:
providing a device such as defined above;
activating the illuminating assembly to generate a focused beam of Airy spot shape;
illuminating the upstream end of the optical fiber with the focused beam of Airy spot shape;
transmitting the light energy injected through the optical fiber as far as a downstream end.

The method of the invention may include one or more of the following characteristics taken alone or in any possible technical combinations:
the device includes a spatial filtering member, the method including the passing of the central disk of the beam of Airy spot shape through the spatial filtering member and the blocking of the secondary rings of the focused beam of Airy spot shape by the spatial filtering member;
the illuminating assembly produces a focused beam of Airy spot shape formed of light pulses, the energy of each light pulse transmitted through the optical fiber being higher than 1 millijoule.

### BRIEF SUMMARY OF THE DRAWINGS

The invention will be better understood on reading the following description given solely as an example with reference to the appended drawings in which:

FIG. 1 is a schematic view of a first device according to the invention;

FIG. 2 is a cross-sectional view of an optical fiber of “kagome” type which can be used in the device in FIG. 1;

FIG. 3 is a graph plotting the transmitted mode profile of the fiber of the device according to the invention, in comparison with the injected mode profile of the illuminating assembly of the invention, and as compared with a Gaussian profile;

FIG. 4 is a similar view to FIG. 1 of a second device according to the invention;

FIG. 5 is a profile view of a focused beam of Airy spot shape generated by the illuminating device; and

FIG. 6 is a view of the uniform, energy profile of the laser beam generated by the source present in the illuminating assembly before it passes through a coupling lens.

### DETAILED DESCRIPTION

In the remainder hereof, the terms “upstream” and “downstream” are to be construed in relation to the normal direction of circulation of a light beam through the device.

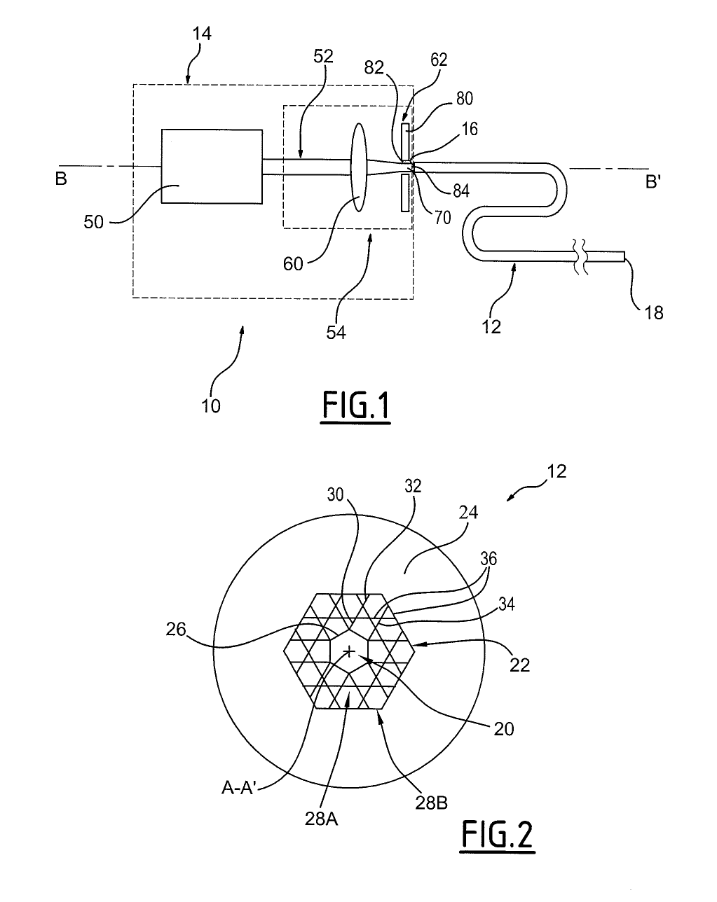

A first energy transmission device 10 according to the invention is illustrated in FIGS. 1 and 2.

The device 10 is intended to generate and convey light pulses of high energy e.g. of energy higher than 1 microjoule, in particular higher than 1 millijoule. These pulses are intended to illuminate a sample for the conducting of spectroscopy, or are intended for the micro-machining of a part. These pulses can also be used for creating a spark intended to ignite a gas mixture present in an engine or turbine.

With reference to FIG. 1, the device 10 includes a hollow-core optical fiber 12 and an illuminating assembly 14 illuminating an upstream end 16 of the optical fiber 12.

According to the invention, the hollow-core optical fiber 12 forms an anti-resonant guide.

The guide is capable of conveying light by anti-resonant optical reflection known as “anti-resonant reflecting optical wave guiding” or ARROW, by confining the transmitted light signal almost nearly within the core of the fiber 12.

As illustrated in FIG. 1, the fiber 12 extends between the upstream end 16 and a downstream end 18 intended to be placed facing an object to be illuminated.

With reference to FIG. 2, the fiber 12 includes a hollow core 20, an anti-resonant inner cladding 22 arranged around the hollow core 20 and a solid outer cladding 24 arranged around the inner cladding 22.

The fiber 12 is of “kagome” type for example.

The length of the fiber 12 between its upstream end 16 and its downstream end 18 is more than 2 centimetres for example and may extend over between 1 m and 100 m.

This is possible having regard to the low losses of these fibers.

The outer diameter of the fiber 12 is generally between 100 micrometres and 1 mm.

The hollow core 20 extends axially in the centre of the fiber 12 over the entire length of the fiber 12. It opens into the upstream end 16 and the downstream end 18.

In this example, the core 20 has a polygonal cross-section, advantageously hexagonal or is formed of a polygon having more than six sides.

Taking into account the type of the anti-resonant inner cladding 22, which is described below, the maximum cross-sectional dimension of the core 20 may be relatively high. This dimension is more than 5 micrometres for example, in particular more than 20 micrometres. Advantageously this dimension is between 5 micrometres and 500 micrometres, in particular between 20 micrometres and 200 micrometres.

The hollow core 20 defines a lumen that is fully clear between the upstream end 16 and the downstream end 18.

As illustrated in FIG. 2, the anti-resonant inner cladding 22 includes an inner tube 26 delimiting the core 20, and at least one peripheral ring 28A, 28B of tubes 30, 32 of polygonal cross-section, advantageously of hexagonal or pseudo-hexagonal cross-section.

The inner tube 26 outerly delimits the hollow core 20. It has a contour section corresponding to the contour of the core 20.

In the example illustrated in FIG. 2, this cross-section is polygonal, in particular hexagonal or formed of a polygon with more than six sides.

The inner cladding 22 has at least two concentric rings 28A, 28B of tubes 30, 32 arranged around the central tube 26. Each tube 30, 32 extends continuously over the entire length of the fiber 12 with a substantially constant cross-section.

In the example illustrated in FIG. 2, the inner ring 28A includes a plurality of main tubes 30, 32 of polygonal cross-section distributed around the axis A-A′ of the fiber 12. In this example, the tubes 30 of the inner ring 28A are of pseudo-hexagonal section taking into account the presence of the central tube 26 with which they share the walls. The tubes 32 of the outer ring are of hexagonal section.

The maximum cross-sectional dimension of the tubes 30, 32 is less than the maximum cross-sectional dimension of the central tube 26.

Advantageously the maximum cross-sectional dimension of each tube 30, 32 is less than once the maximum cross-sectional expanse of the core 20.

Each main tube 30, 32 is adjacent a plurality of other tubes 30, 32 along a common longitudinal edge 34 which extends over the entire length of the fiber 12. Therefore each tube 30, 32 is connected to at least one other tube 30, 32 along a generating line over the full length of the fiber 12.

The main tubes 30, 32, between their common edges 34, delimit a plurality of intermediate tubes 36 of smaller cross-section advantageously triangular. The intermediate tubes 36 have maximum cross-sectional dimensions smaller than those of the main tubes 30, 32. The intermediate tubes 36 therefore have an inner lumen that is fully clear over the entire length of the fiber 12.

Therefore each main tube 30 of pseudo-hexagonal section or each main tube 32 of hexagonal section is surrounded by a plurality of auxiliary tubes 36 of triangular section defining a general lattice in the shape of a Star of David. The inner cladding hollow structure 22 is known as a “kagome” structure.

The cladding 22 and in particular the walls defining the tubes 30, 32, 36, 26 are made of silica for example. These walls have a maximum thickness that is less than 10 micrometres.

The maximum thickness of the inner cladding 22, taken between the central tube 26 and the outer cladding 24, is more than 10 micrometres for example and is between 5 micrometres and 500 micrometres. The cladding 22 ensures anti-resonant guiding of a light beam passing through the core 20.

By “anti-resonant cladding” is meant that less than 0.1% of the light energy introduced into the fiber 12 circulates in the inner cladding 22, the light energy being substantially fully confined within the core 20. The anti-resonant nature of the cladding 22, and in particular the quantity of energy circulating in the cladding 22, can be measured for example using the experimental method disclosed in the article “Large-pitch kagome-structured hollow-core photonic crystal fiber”; Opti Letters 31, 3574-3576 (2006).

The measurement is advantageously taken at the wavelength of the beam emitted by the illuminating assembly 14, e.g. 1064 nm. By moving radial to the axis A-A′ of the fiber 12, the energy present at every point of the cladding 22 is less than 0.1% of the energy present at the centre of the core 20, having regard to the anti-resonant nature of the cladding 22.

As specified above, the outer cladding 24 is solid. For example it is silica-based. The maximum thickness of the outer cladding 24 is more than 20 micrometres for example and is particularly between 5 micrometres and 500 micrometres.

The fiber 12 is capable of guiding a light beam over wide spectral bands, for example wider than several hundred THz from the ultra-violet (of the order of 200 nm) to the middle infrared (of the order of 3000 nm) with relatively small losses. For example the losses through the fiber 12 are less than 200 dB per kilometre, in particular of the order of 100 dB per kilometre.

On account the anti-resonant guiding, the fiber 12 displays strong confinement of the light signal within the core 20, and a very small overlap of the light signal with the rings 28A, 28B.

By “small overlap” is meant that the energy transmitted through the rings 28A, 28b of the outer cladding 24 is less than 0.1% of the total energy injected into the fiber 12, in particular at a wavelength of 1064 nanometres.

The illuminating assembly 14 of the fiber 12 is capable of generating a focused beam of Airy spot shape. With reference to FIG. 1, it includes a laser source 50 capable of producing a uniform light beam 52 and coupler 54 between the laser source 50 and the upstream end 16 of the fiber 12.

The laser source 50 includes at least one laser cavity (not illustrated).

The light beam emitted by the source 50 is advantageously a laser beam of circular section. As illustrated in FIG. 6, in the near field it has a uniform profile of energy density E over its radial expanse e.

By “uniform circular beam” is meant that the beam has a substantially uniform energy density within a circular disk.

By “substantially uniform” is meant that the maximum variation in energy density within the circular disk is less than 30%.

The beam can be designated as a “flat beam” or a “top hat beam” for example.

By “near field” is meant at a distance less than or of the same order of magnitude as the Rayleigh distance Zr calculated using the equation

$${Z}_{R} = \frac{π {W}_{0}^{2}}{λ}$$

where wo is the diameter of the beam and λ is the wavelength of the source.

If the diameter of the laser beam is of the order of one millimetre, the wavelength is 1 μm, the Rayleigh distance Zr is of the order of about 3 metre, where wo is the diameter of the beam and λ is the wavelength of the source

To produce the beam 52, the laser source 50 includes an unstable laser cavity for example associated with a gradient-reflectivity mirror (GRM).

A source 50 of this type is a Nd:YAG type laser for example, emitting at a wavelength of the order of 1064 nanometres. A source of this type is marketed by QUANTEL under the trade name QUANTEL ULTRA with GRM cavity.

As a variant, the laser source 50 includes a stable laser cavity, producing an output beam of Gaussian profile for example. The laser source 50 then includes a beam shaping device to obtain a uniform beam 52 such as defined above.

Therefore, the laser source 50 is capable of generating a beam 52 advantageously formed of light pulses lasting between 100 fs and 100 ns, in particular between 1 ns and 20 ns.

The light energy of the pulses is between 0 and 50 millijoules for example, in particular more than 1 microjoule and advantageously more than 1 millijoule. In this respect, a variable attenuator is advantageously inter-positioned downstream of the laser cavity to regulate the energy of each pulse.

The beam 52 has a wavelength of between 300 nm and 2000 nm, in particular between 500 nm and 1100 nm, for example 532 nm or 1064 nm.

The coupler 54 includes a coupling lens 60 capable of generating, from the uniform beam 52, a beam 70 of Airy spot shape at the upstream input 16 of the fiber 12, and a spatial filtering member 62 filtering the Airy spot-shaped beam 70.

The coupling lens 60 is a convergent lens. It has a focal distance adapted to cause the Airy spot formed at the focal point of the coupling lens to correspond to the propagation mode of the fiber 12.

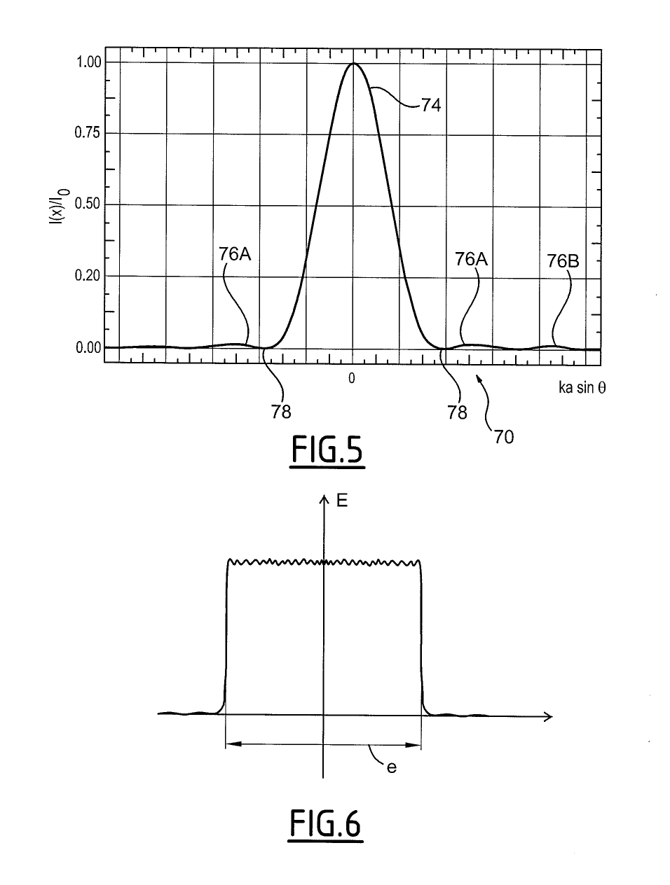

As illustrated in FIG. 5, the beam 70 has an Airy spot transverse profile which follows a first order Bessel function as per the equation below:

$$I ( θ ) = {{I}_{0} ( \frac{2 {J}_{1} ( ka sin θ )}{ka sin θ} )}^{2} = {{I}_{0} ( \frac{2 {J}_{1} ( x )}{x} )}^{2}$$

where I₀ is the maximum intensity at the centre of the disk, J1 is a first order Bessel function, a is the diameter of the beam upstream of the lens 60, K=2π/λ is the number of waves, where λ is the wavelength and θ is the ratio of the radial distance r of the Airy spot to the focal distance d of the coupling lens 60.

The Airy spot has a central disk 74 and a plurality of secondary rings 76A, 76B with two minima 78 of substantially zero value between the central disk 74 and the first secondary ring 76A.

The upstream end 16 of the fiber 12 is positioned in the axis B-B′ of the coupling lens 60, in the vicinity of the downstream focal point of the lens 60. The focal distance of the lens 60 is adjusted so that the transverse expanse of the central disk 74 of the Airy disk 70, taken between its minima 78, is substantially equal to the mean transvers expanse of the core 20.

Therefore the numerical aperture of the beam 70 focused at the upstream end 16 of the fiber 12 is substantially equal to the numerical aperture of the fiber 12.

In this example the spatial filtering member 62 includes a body 80 opaque to the light rays generated by the laser source 50, and a central opening 82 transparent to the light rays generated by the laser source 50.

The dimensions of the central opening 82 are chosen to allow the passing of the central disk 74 of the Airy disk-shaped beam 70 and to block the secondary rings 76A, 76B.

Therefore, in the example illustrated in FIG. 1, the spatial filtering member 62 is advantageously arranged at the upstream end 16 of the fiber 12, perpendicular to the axis B-B′ of the lens 60.

In this case, the transverse expanse of the central opening 82 which can be seen in FIG. 1 is substantially equal to the distance separating the minima 78 of the central disk 74 of the Airy disk 70 shown in FIG. 5.

The focused output beam 84 thus obtained downstream of the filtering member is therefore of Airy disk shape solely including the central disk 74, which further limits the propagation of energy through the inner cladding 22 of the fiber.

The light energy transmitted in the fiber 12 is therefore substantially solely injected into the hollow core 20. This maximizes the energy transmitted through the fiber 12 reducing the risk of deterioration of the inner cladding 22 of the fiber 12, or even breakdown.

Since the illuminating assembly 14 of the invention generates a focused beam of Airy disk shape, substantially zero energy minima 78 are present around the central disk 74.

The combination of an illuminating assembly 14 producing an Airy disk-shaped focused beam with an optical fiber 12 having an anti-resonant inner cladding considerably reduces the energy transmitted through the cladding 22 of the fiber 12, whilst perfectly adapting the mode injected into the fiber 12 to the propagation mode of the fiber 12.

The overlap of the propagated mode with the tubes 30, 32 of the inner cladding 22 is therefore very limited and the profile of the incident beam input into the fiber is fully adapted to the profile of the mode transmitted by the fiber 12.

It is therefore possible to propagate a beam almost exclusively in the gas-filled core 20, which significantly increases the damage threshold of the fiber 12, in particular as compared with a fiber having a solid silica core or compared with a hollow-core fiber having a photonic band gap such as described in U.S. Pat. No. 7,099,533.

In one particular embodiment, when the mode diameter of the fiber is 60 micrometres, the output diameter of the laser beam generated by the source 50 is 2.8 millimetres and the calculated focal distance of the coupling lens 60 is 69 millimetres.

To provide for tolerance on the positioning of the beam at the input to the fiber 12, a lens 60 having a slightly shorter focal distance e.g. of the order of 56 millimetres can be used, which generates a slightly larger numerical aperture than the numerical aperture of the fiber.

The fiber 12 associated with the illuminating assembly 14 is capable of withstanding pulses lasting in the order of one nanosecond with energy higher than 1 millijoule, in particular of the order of 4 millijoules. This represents an improvement by a factor of 6 compared with fibers known in the state of the art.

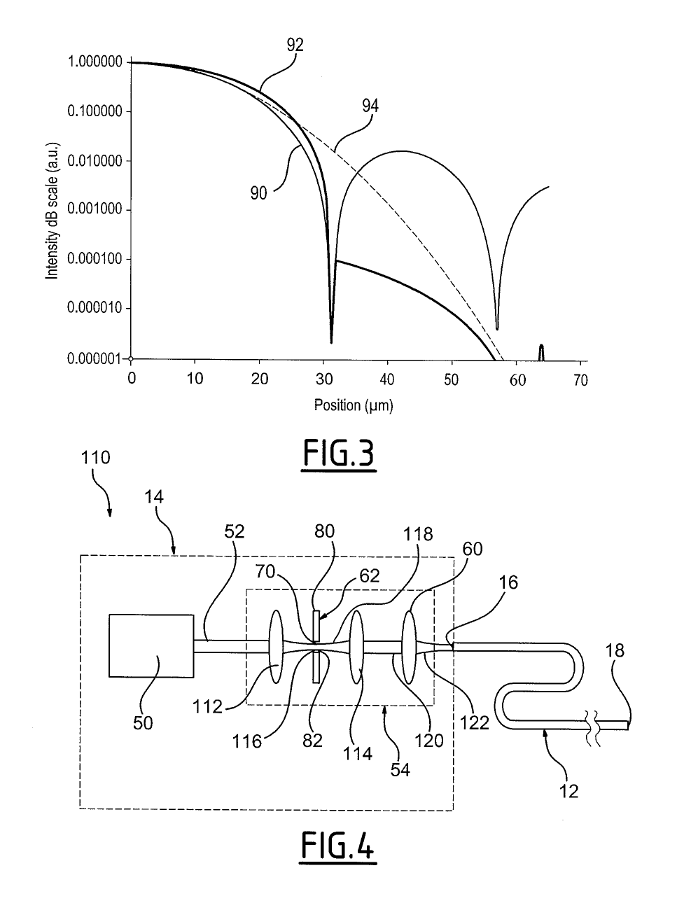

As illustrated in FIG. 3, the profile 90 of the beam injected into the fiber 12, shown as a thin solid line, is adapted to the profile 92 of the propagation mode in the fiber 12, which is not the case with a Gaussian profile 94 illustrated as a dotted line in this same figure.

The functioning of the transmission device 10 according to the invention is as follows.

Initially, the laser source 50 generates a uniform circular beam 52 such as described above and below.

This beam 52 is formed for example of light pulses of wavelength between 500 nanometres and 1100 nanometres, and of energy higher than one microjoule advantageously higher than 1 millijoule.

The light pulses last between 100 fs and 100 ns.

The beam 52 is then directed towards the coupling lens 60 along axis B-B′ thereof. The lens 60 causes the beam 52 to converge to form a coupling beam 70 of Airy disk shape at the downstream focal point of the coupling lens 60.

This beam is spatially filtered by the filtering member 62 which only allows the passing of the central disk 74 through the central opening 82 by blocking the secondary rings 76A, 76B.

The focused output beam 84 obtained downstream of the filtering member 62 is then injected into the fiber 12. This beam solely includes the central disk 74 of the Airy disk 70. It is injected into the hollow core 20 of the fiber 12. Having regard to the anti-resonant nature of the inner cladding 22, the injected beam propagates through the fiber 12 between the upstream end 16 and the downstream end 18, being substantially fully confined within the core 20. It leaves the fiber 18 at its downstream end for use in the applications described above.

A second device 110 according to the invention is illustrated in FIG. 4. Unlike the device 10 shown in FIG. 3, the coupler 54 of the device 110 include an auxiliary upstream lens 112, and an auxiliary downstream lens 114 arranged upstream of the coupling lens 60. The lenses 112, 114 form a telescope system.

In this example, the filtering member 62 is arranged between the lenses 112, 114 at the downstream focal point of the auxiliary upstream lens 112.

The auxiliary upstream lens 112 is therefore capable of focusing the uniform beam 52 derived from the laser source 50 at its downstream focal point 116, to allow the formation of a beam 70 of Airy disk shape.

The filter member 62 then filters the secondary rings 76A, 76B of the Airy spot-shaped beam 70 thus formed, so as only to allow the passing of the central disk 74.

The output beam 118 thus obtained is then collimated by the downstream lens 114 to obtain a uniform downstream beam 120.

Advantageously the upstream lens 112 and the downstream lens 114 have identical focal distances, so that the magnification through the lenses 112, 114 is unitary.

The uniform downstream beam 120 is then directed towards the coupling lens 60 along its axis to allow the injection of a focused beam 122 having a central disk of Airy disk shape at the upstream input 16 of the fiber 12.

In one advantageous variant, the lenses 112, 114 have a larger focal distance than the focal distance of the coupling lens 60. Therefore, the diameter of the central disk 74 of the Airy spot 70 formed at the downstream focal point 116 of the first lens 112 has a transverse expanse that is larger than the central disk of the beam injected into the fiber 12.

The filtering member 62 has an increased diameter, and the opening 82 can be of larger dimension which reduces the power density applied to the opaque body 80 at the second rings 76A, 76B of the Airy spot-shaped beam 70.

In one variant (not illustrated), the anti-resonant cladding 22 of the fiber 12 includes a central tube of polygonal section, in particular hexagonal, outerly delimiting the hollow core 20 and a single ring 28A of adjacent main tubes which are partly delimited by the central tube and partly by the outer cladding 24. The fiber is illustrated for example in FIG. 1 of the article “Simplified Hollow-Core photonic crystal fiber” Optic Letters, 35, 1157-1159 (2010).

Other variants of anti-resonant claddings 20 can be designed by persons skilled in the art.

What is claimed is:

1. A device for transmitting laser energy comprising:
an optical fiber including a hollow core and an anti-resonant annular cladding arranged around the hollow core;
an illuminator illuminating the optical fiber at an upstream end of the optical fiber, the illuminator generating a focused beam of Airy spot shape for injection at the upstream end of the optical fiber.

2. The device as recited in claim 1 wherein the focused beam of Airy spot shape generated by the illuminator has a central disk of a diameter substantially equal to a maximum transverse expanse of the hollow core of the optical fiber.

3. The device as recited in claim 1 wherein that the illuminator includes a laser source and a coupler between the laser source and the optical fiber, the coupler including at least one convergent coupling lens having a downstream focal point arranged in a vicinity of the upstream end of the optical fiber.

4. The device as recited in claim 1 wherein the illuminator includes a spatial filter capable of preventing the passing of the secondary rings of the Airy spot-shaped beam.

5. The device as recited in claim 4 wherein the spatial filter is arranged facing the upstream end of the optical fiber.

6. The device as recited in claim 4 wherein the spatial filter is arranged between two auxiliary lenses located upstream of the upstream end.

7. The device as recited in claim 1 wherein the illuminator includes a laser source capable of generating a near field, uniform circular beam.

8. The device as recited in claim 7 wherein the laser source is one of a laser source including an unstable cavity and gradient-reflectivity mirror or a laser source including a spatial beam-modulation system.

9. The device as recited in claim 1 wherein the anti-resonant annular cladding includes at least one ring of adjacent main hollow tubes, the main hollow tubes delimiting between them intermediate tubes of smaller cross-section than a cross-section of the main hollow tubes.

10. The device as recited in claim 1 wherein the hollow core is limited by a central tube of polygonal shape.

11. The device as recited in claim 1 wherein a maximum transverse dimension of the hollow core is greater than 5 micrometres.

12. The device as recited in claim 1 wherein a maximum transverse dimension of the hollow core is greater than 20 micrometres.

13. The device as recited in claim 1 wherein a maximum transverse dimension of the hollow core is between 50 micrometres and 500 micrometres.

14. The device as recited in claim 1 wherein the illuminator is capable of emitting a plurality of light pulses of energy higher than 1 millijoule.

15. A method for transmitting light energy comprising:
providing the device as recited in claim 1;
activating the illuminator to generate a focused beam of Airy spot shape;
illuminating the upstream end of the optical fiber with the focused beam of Airy spot shape; and
transmitting light energy injected through the optical fiber as far as a downstream end of the optical fiber.

16. The method as recited in claim 15 wherein the device includes a spatial filter, the method including passing a central disk of the Airy-spot shaped beam through the spatial filter and blocking secondary rings of the focused beam of Airy spot shape with the spatial filter.

17. The method as recited in claim 15 wherein the illuminator produces a focused beam of Airy spot shape formed of light pulses, an energy of each light pulse transmitted through the optical fiber being higher than 1 millijoule.
